(19) United States
(12) Patent Application Publication
(10) Pub. No.: US 2008/0072484 A1
(43) Pub. Date: Mar. 27, 2008

(54) FLOWER BOUQUET HOLDER AND DISPLAY STAND

(75) Inventors: Paul Giampavolo, Fairfield, NJ (US); Robert N. Shelton, Princeton, MA (US)

Correspondence Address: OSTROLENK FABER GERB & SOFFEN, 1180 AVENUE OF THE AMERICAS, NEW YORK, NY, 100368403, US

(73) Assignee: Paul Giampavolo, Fairfield, NJ (US)

(21) Appl. No.: 11/946,418

(22) Filed: Nov. 28, 2007

Related U.S. Application Data
(62) Division of application No. 10/138,979, filed on May 3, 2002.
(60) Provisional application No. 60/288,849, filed on May 4, 2001.

(51) Int. Cl. A01G 5/04

(52) U.S. Cl. 47/41.01

(57) ABSTRACT

A flower bouquet holder is cone shaped and has a support bracket for attaching the holder to a shopping cart. The holder can have a water-tight bottom portion for holding water supplied to the flowers while in the holder. The holder can also have an open bottom, with a removable insert placed in the bottom to prevent escape of the flowers or water supplied to the flowers. The support bracket can provide a permanent or temporary attachment to the shopping cart. The flower holder can be stored on a display stand arranged to accommodated stacked flower holders in an inverted or upright position. The display stand can be provided with display information for shoppers related to use of the flower holders. The flower holders are generally weather resistant for indoor and outdoor use.

### CROSS-REFERENCE TO RELATED APPLICATIONS

This is a divisional of U.S. patent application Ser. No. 10/138,979 filed May 3, 2002 in the name of Paul Giampavolo and entitled BOUQUET HOLDER AND DISPLAY STAND, which application is based on and claims benefit of U.S. Provisional Application No. 60/288,849, filed on May 4, 2001, entitled Flower Bouquet Holder for Attaching to Shopping Cart, to which a claim of priority is hereby made.

### BACKGROUND OF THE INVENTION

1. Field of the Invention

The present invention relates generally to flower bouquet holders and display/dispenser stands for the same. More particularly, the present invention relates to flower bouquet holders for the temporary transportation of flower bouquets in or on a shopping cart, the flower bouquet holders permanently or removably attached to the shopping cart, and for presentation stands for displaying and dispensing the holders.

2. Description of Related Art

Fresh flowers are often sold in retail establishments frequented by shoppers who gather selected items in a shopping cart. Among other items offered in the retail shops, fresh flowers are relatively very delicate and cannot easily be accommodated in a shopping cart. When fresh flowers are placed in a shopping cart, especially among other selected items, instances of damage to the flowers often occur.

Fresh flowers on display in retail shops are typically arranged to be standing up, i.e., the position of the flowers is more closely related to the natural position for flowers. However, when flowers are selected for purchase and placed in a shopping cart or carriage, the most simple option for placement in the shopping cart, is to lay the flowers flat. The flat position for the flowers is more likely to cause damage to the flowers, as well as taking up greater room in the shopping cart. When greater room is taken in the cart, other selected items can unintentionally or accidentally be placed on or near the flowers thereby causing further damage to the flowers.

To avoid the above problems, attempts may be made by the shopper to place the flowers in an upright position in the shopping cart. However, shopping carts typically have no stable structure for insuring that the flowers remains upright. In addition, carts are often constructed with a widely spaced mesh, such that flowers placed in an upright position in the cart are likely to fall through the spaces between the mesh.

In addition, flowers selected from a store flower display are often wet, especially the flower stems, owing to the usual practice of placing fresh flowers in buckets containing water to keep the displayed flowers fresh. When a shopper selects fresh flowers for purchase, and places the wet flowers in the shopping cart, water can drip onto the floor of the shopping establishment. The dripped water leads to a potentially hazardous condition, where store patrons can slip and fall, leading to serious injury. Since the flowers are transported throughout the store in the shopping cart, a potentially hazardous condition can exist in many locations and at random times throughout the store.

Attempts to remedy the above problem typically require the shopper to obtain a plastic bag to prevent water drips. However, inconsistencies among shopper usage prevents complete coverage and prevention of the above problem, even when appropriate methods are available to remedy the situation. For example, the plastic bags may be awkward or cumbersome to use, potentially deterring shoppers from using the available plastic bags. In addition, the insertion of the flowers into the plastic bag may damage the flowers.

Although some provision can be made by shopping cart manufacturers to accommodate a flower holder in a shopping cart, these holders may not retain water, or may be part of the permanent cart structure, and thus inflexible in use. Moreover, the holders by cart manufacturers my damage the stems, foliage or blossoms of the flowers.

### SUMMARY OF THE INVENTION

It is an object of the present invention to overcome the above described drawbacks and to provide a flower bouquet holder that can be used with a shopping cart. The flower bouquet holder can be clipped, with or otherwise attached onto a shopping cart by a simple means that can be easily operated by a typical shopper. Alternately, the flower bouquet holder can be attached to the shopping cart prior to use by a shopper. For example, the holder is permanently attached to the shopping cart.

The flower bouquet holder according to the present invention can also be made water impermeable to prevent water on the fresh flowers from dripping on the shop floor as the flowers are transported around the shop in the cart. In addition, the flower bouquet holder can be filled with water to keep the flowers fresh, as the shopper is selecting other items throughout the shop.

The flower holder according to the present invention can be arranged within the contours of the cart and externally on the cart for convenience. The holder can preferably be placed externally on the cart to provide greater available space within the cart for other items.

The flower bouquet holder may be conical or tapered in shape to provide a simple means of receiving flowers bunches or bouquets that may have many stems. The flower bouquet with many stems can be received by the flower bouquet holder by inserting the stems into a wider mouth portion of the flower bouquet holder. The flower stems are then collected together as the flowers are further inserted in the smaller circumference portions of the conically shaped holder.

According to one aspect of the present invention, the lower portion of the holder is open. The opening in the lower portion of the holder is suitable for receiving a replaceable cup or bag. The replaceable cup or bag can be used to prevent water leakage and to hold the flower stems upon the flowers being inserted into the flower holder. The replaceable cup or bag can be replaced after each use or as needed according to the customs of the shop and the shopper.

Alternatively, the holder can have a detachable bottom portion that can be easily assembled to the holder. The bottom portion can be tethered to the holder, and can be configured to form a water-tight seal with the holder. The bottom portion can thus hold water, and contribute to holding water at a higher level within the flower holder when assembled, due to the water-tight seal. The water-tight seal can be configured in such a way to be repeatedly sealable, while being quickly and easily attached or detached. By providing an open bottom to the flower holder, water accumulated in the holder from, for example, precipitation while the holder is outside the shop can be easily and quickly removed. If the bottom portion of the flower holder is left unattached, then water does not accumulate in the holder because of the open bottom.

The flower holder can be formed to have a hook that slides simply onto an edge of the cart, and can be removed after each use. The holder can alternatively be secured to the cart by cable ties, for example, or other brackets or securing means. The securing means can be arranged to be somewhat permanent, and attachable without the need of tools. The flower holder can be arranged inboard or outboard on the cart, attached to an interior or exterior of the cart, and switchable between inboard and outboard arrangements. In each case, the holder can be made to be weather resistant so that exposure to the elements does not seriously degrade the quality or the functionality of the flower holders.

The flower bouquet holder can be made of any suitable material including plastic. For example, the flower holder can be metal, treated cardboard, fiberboard material and any other suitable material. The flower holder need not be formed of a single material, but can be composed of a variety of materials. For example, the flower holder can be woven or composed of fabric, or a combination of solid and woven materials. In addition, the flower holder can have a support member made of different material than the holder body.

The flower bouquet holders are preferably formed to be stored in a compact format, such as being stackable. Preferably, the flower holders fit within each other so that a number of flower holders can be stacked, transported or stored easily. Preferably, the flower holders are cone shaped to be easily received within each other while easily holding flowers. The cone shaped flower holders can have a taper that permits the holders to be easily separated from one another. Alternatively, the cone shaped flower holders can have ribs, protrusions or other means to prevent the flower holders from sticking to each other when stacked, and permit their easy removal from each other. A stackable flower holder can take any tapered or columned form, including a tetrahedral shape, half-or quarter circle shapes and cornered shapes having arcuate surfaces.

A flower holder according to the present invention that is removable from a cart can be stored with other similar flower holders in a display stand. The display stand permits the flower holders to be stacked and easily noticed by shoppers, so that a shopper can easily observe the flower holder and easily obtain a holder and install the same on a cart. The display stand can preferably have receiving portions shaped to accept a flower holder, so that additional flower holders can be stacked on top of each other in the display. With the display stand according to the present invention, shoppers can be advised of the availability of flower holders and can easily remove a flower holder from the stand for use with a cart. The stand can also support a sign to encourage shoppers to obtain a flower holder for use with purchasing flowers.

### BRIEF DESCRIPTION OF THE DRAWINGS

The present invention is now explained in further detail in the following description to be read in accompaniment with the drawings, in which.

FIG. 1 shows a perspective view of an embodiment of the flower holder according to the present invention;

FIG. 2 shows a typical shopping cart fitted with a holder according to the present invention;

FIG. 3 is a perspective view of another embodiment of the holder of the present invention;

FIG. 4 is a perspective view of the embodiment of FIG. 3 attached to the side of a cart;

FIG. 5 shows a perspective view of another embodiment of a holder according to the present invention;

FIG. 6 shows a different perspective view of the embodiment of FIG. 5;

FIG. 7 shows a perspective view of another embodiment of a holder according to the present invention;

FIG. 8 shows a perspective view of the embodiment of FIG. 7 attached to a side of a shopping cart;

FIG. 9 shows a perspective view of another embodiment of a holder of the present invention;

FIG. 10 shows another perspective view of the embodiment of FIG. 9;

FIG. 11 shows a perspective view of the embodiment of FIG. 9 attached to a corner of a shopping cart;

FIG. 12 shows a perspective view of another embodiment of a holder according to the present invention;

FIG. 13 shows another perspective view of the embodiment of FIG. 12;

FIG. 14 shows a perspective view of another embodiment of a holder according to the present invention;

FIG. 15 shows another perspective view of the embodiment of FIG. 14;

FIG. 16 is a perspective view of a display stand according to the present invention;

FIG. 17 is another perspective view of the embodiment of FIG. 16;

FIG. 18 is a perspective view of the embodiment of FIG. 16 including stored flower holders and a display presentation;

FIG. 19 shows another perspective view of the embodiment of FIG. 18;

FIG. 20 is a perspective view of another embodiment of a display stand according to the present invention;;

FIG. 21 is another perspective view of another embodiment of a display stand according to the present invention;

FIG. 22 is a perspective view of another embodiment of a display stand according to the present invention;

FIG. 23 is a perspective view of a display stand according to another embodiment of the present invention;

FIG. 24 is a display stand according to another embodiment of the present invention;

FIG. 25 is a perspective view of another embodiment of a display stand according to the present invention;

FIG. 26 is a perspective view of another embodiment of a display stand according to the present invention;

FIG. 27 is a perspective view of another embodiment of a flower holder according to the present invention;

FIG. 28 is a perspective view of another embodiment of a flower holder according to the present invention; and

FIG. 29 shows several perspective views of further embodiments of flower holders according to the present invention.

### DETAILED DESCRIPTION OF THE PREFERRED EMBODIMENTS

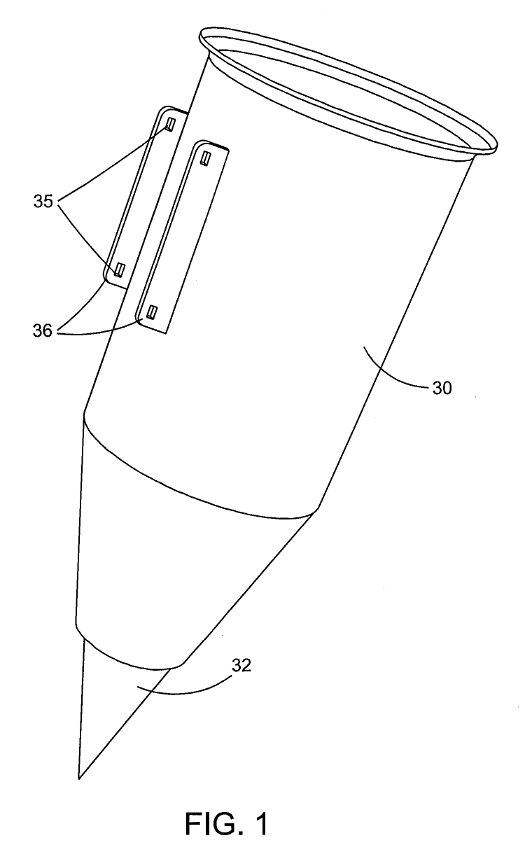

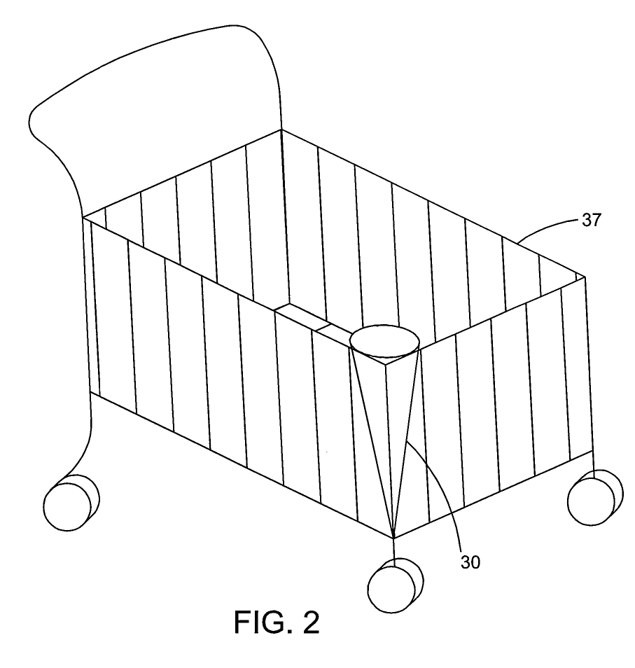

Referring now to FIG. 1, an embodiment according to the present invention shows a flower holder with a replaceable bottom. The holder has an opening 34 for receiving flower stems to be held in the flower bouquet holder 30. Flower bouquet holder 30 has elongated projections 36 on a side of holder 30 for attaching holder 30 to a cart 37 (FIG. 2). Projections 36 have openings 35 to receive an attaching device, such as cable ties, attachment rings, and so forth. The attaching devices can be threaded through openings 35 and attached around a structural element of cart 37 to secure holder 30 in place.

Holder 30 has a replaceable bottom 32 that can be in the form of a plastic or paper cup or bag. Replaceable bottom 32 serves as an end of holder 30 and can prevent the flower stems inserted in opening 34 from dropping out of holder 30, in addition to preventing water that can be on the flower stems from dripping out of holder 30. Replaceable bottom 32 can extend into only a portion of holder 30, or can extend the entire length of holder 30 and protrude out of opening 34. In such an arrangement, flower stems can be received in replaceable bottom 32, prior to replaceable bottom 32 being placed into holder 30. Accordingly, replaceable bottom 32 can be used as a wrapper for flowers that are held in holder 30.

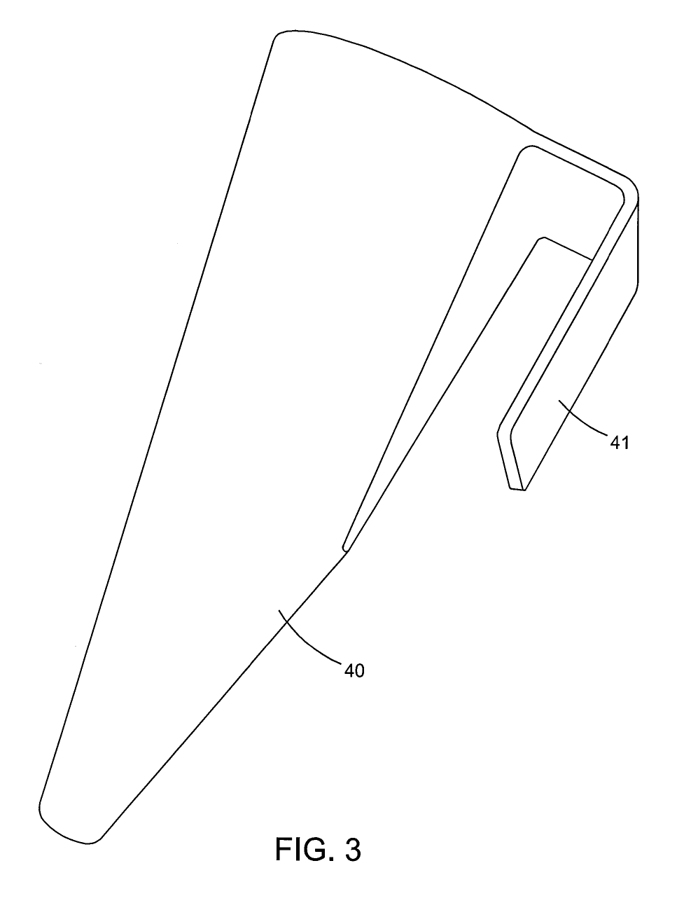

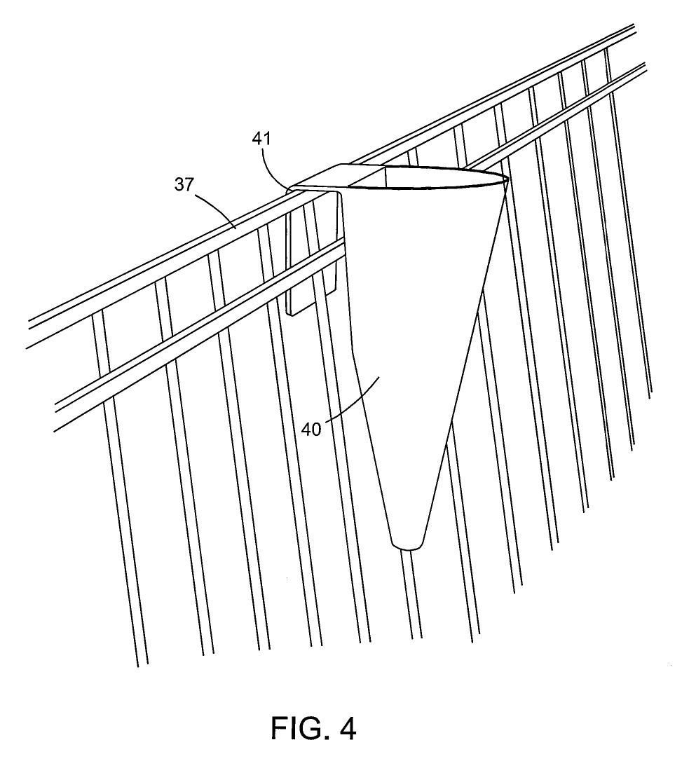

Referring now to FIG. 3, another embodiment of the present invention is shown generally as holder 40. A bracket 41 extends from a top of holder 40 and is shaped to slide over the edge of a cart wall. Referring now to FIG. 4, holder 40 is shown with bracket 41 placed over a wall of cart 37. It should be noted that this arrangement of holder 40, as well as holder 30 as shown in FIG. 1, can be placed either inside or outside of the cart. In either case, holder 40 is supported by and secured to cart 37 and permits flower bouquets to be stored therein simply and without damage to the bouquets.

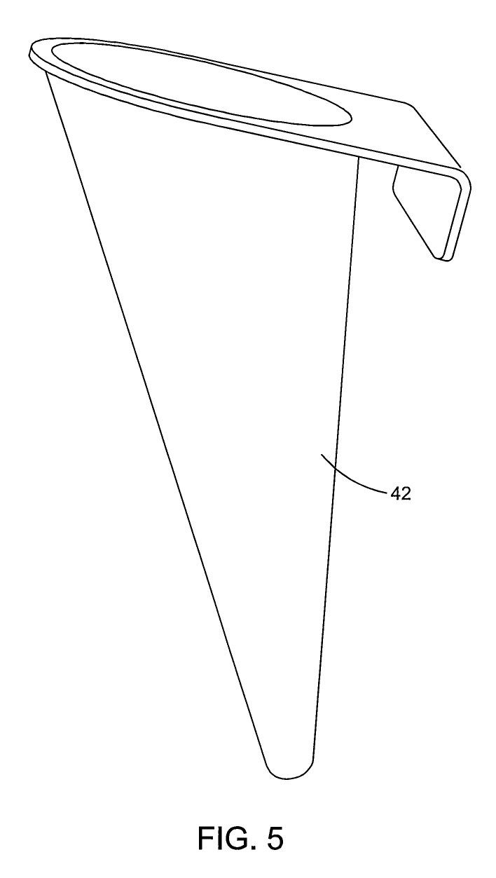

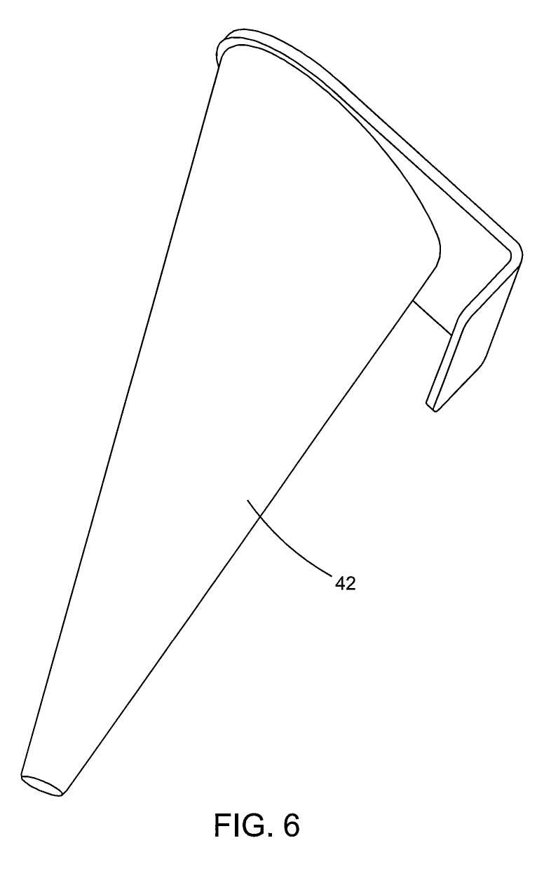

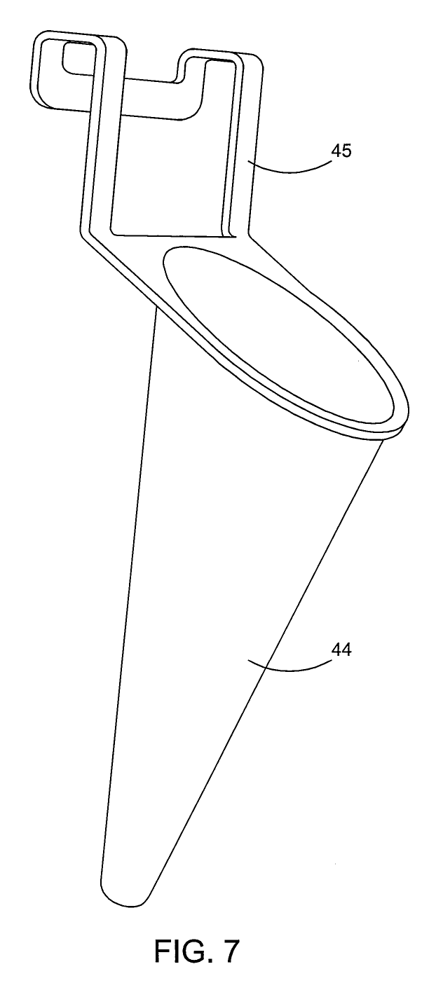

Referring now to FIGS. 5 and 6, another embodiment of the present invention is shown as holder 42. Holder 42 is similar to holder 40, with the difference being that holder 40 has a planar edge presented to the wall of cart 37, while holder 42 is substantially entirely cone shaped. In addition, a longitudinal edge of holder 42 can be aligned with the wall of cart 37 on which holder 42 is placed.

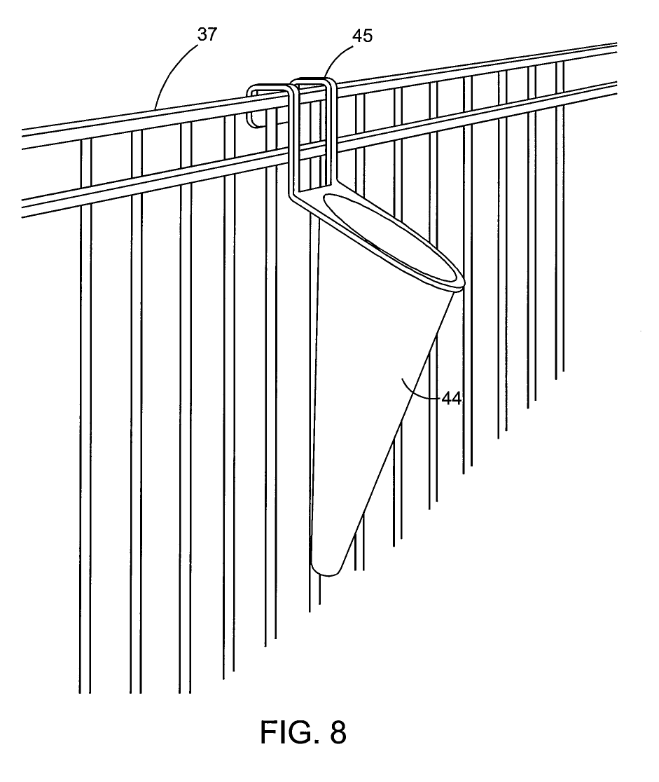

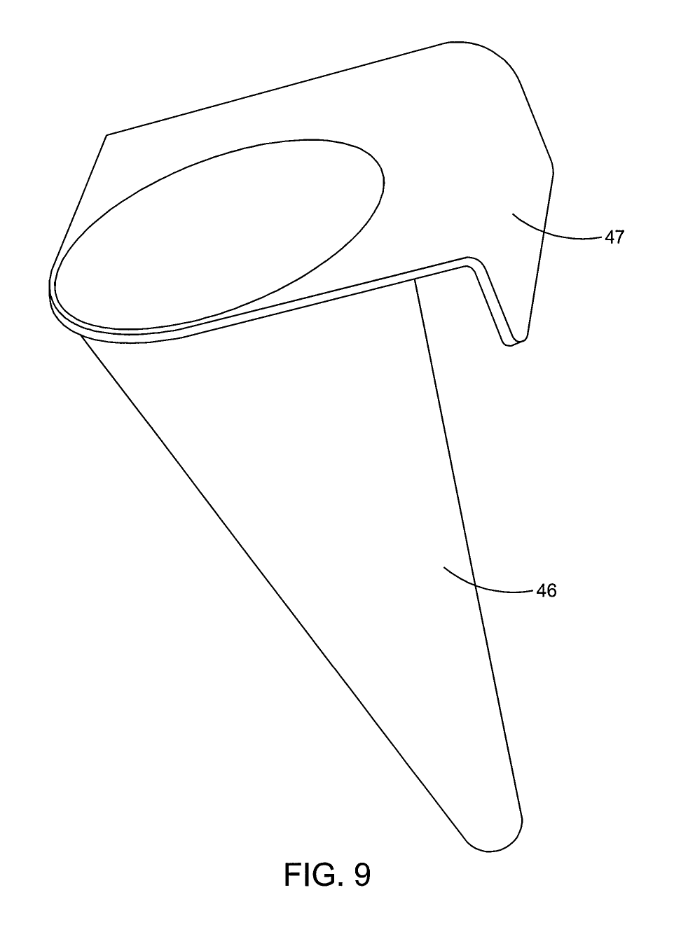

Referring now to FIGS. 7 and 8, another embodiment of the present invention is shown as holder 44. Holder 44 has a bracket 45 formed as a shaped single strip of material to support holder 44. The design of the embodiment shown as holder 44 permits holder 44 to be constructed with less material.

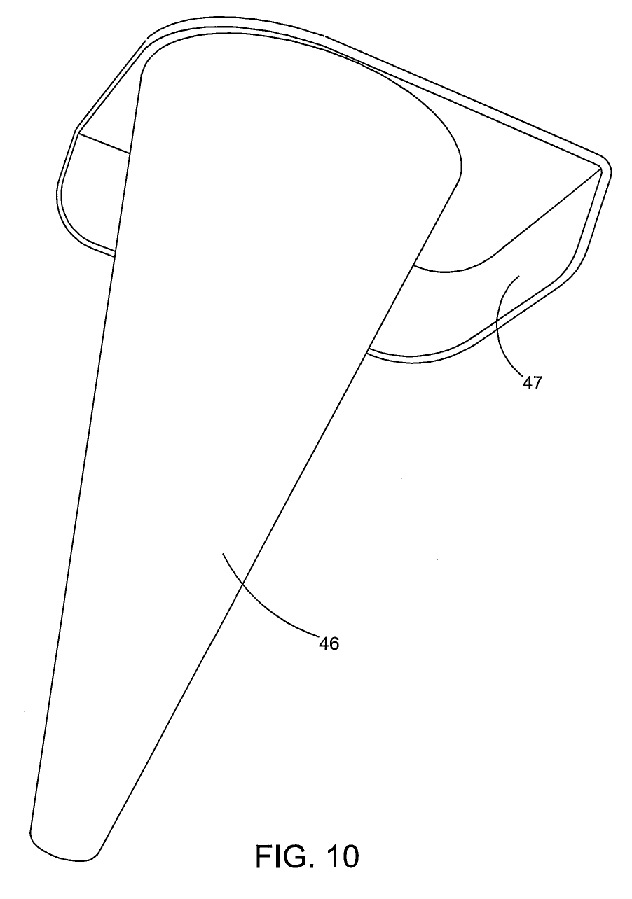

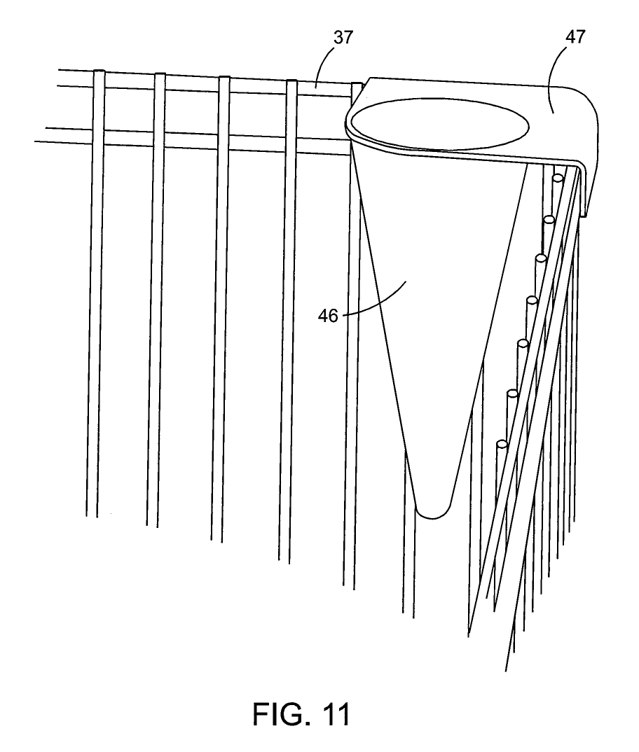

Referring now to FIGS. 9-11, another embodiment of the present invention is shown as holder 46. Holder 46 is designed to fit on a corner of cart 37. Bracket 47 is shaped as a corner bracket to lay over the corner of two walls of cart 37. The embodiments of holder 46 can provide greater stability for supported flower bouquets because of the extra supporting surface provided by bracket 47.

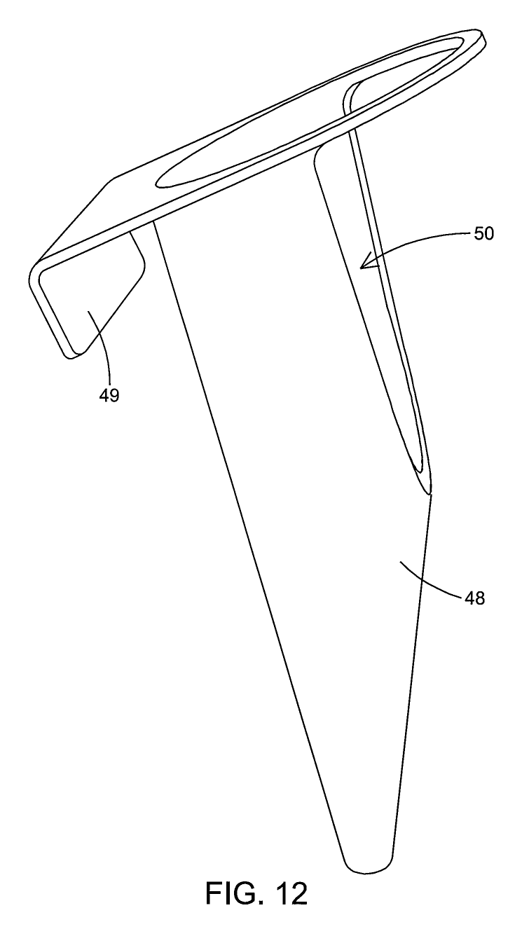

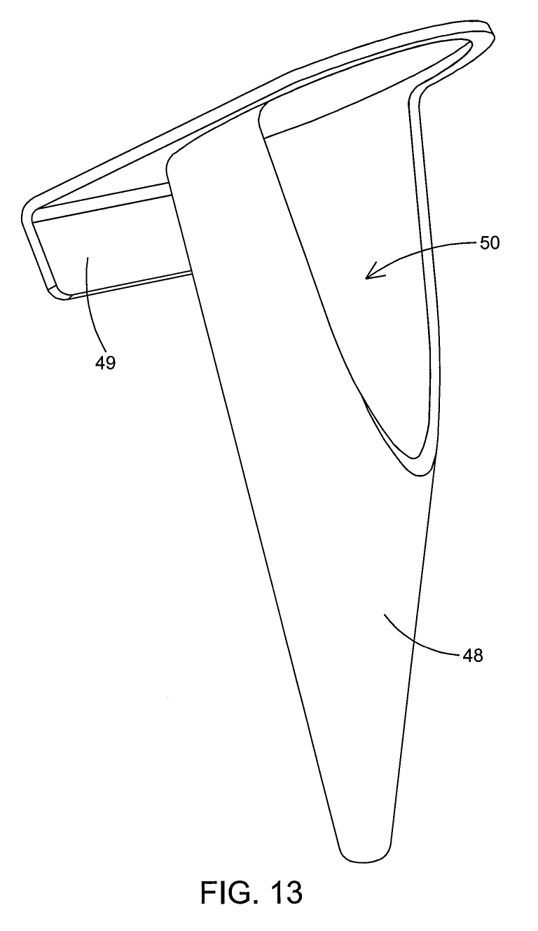

Referring now to FIGS. 12 and 13, another embodiment of the present invention is shown as holder 48. As with the previous embodiments, holder 48 has a bracket 49 for attachment of holder 48 to a wall of a cart. Holder 48 also has a cutaway portion to provide an opening 50 in a side of holder 48. The structure of holder 48 with opening 50 permits holder 48 to be constructed with less material than with other embodiments. In addition, flower bouquets supported by holder 48 can be more easily accessed through opening 50.

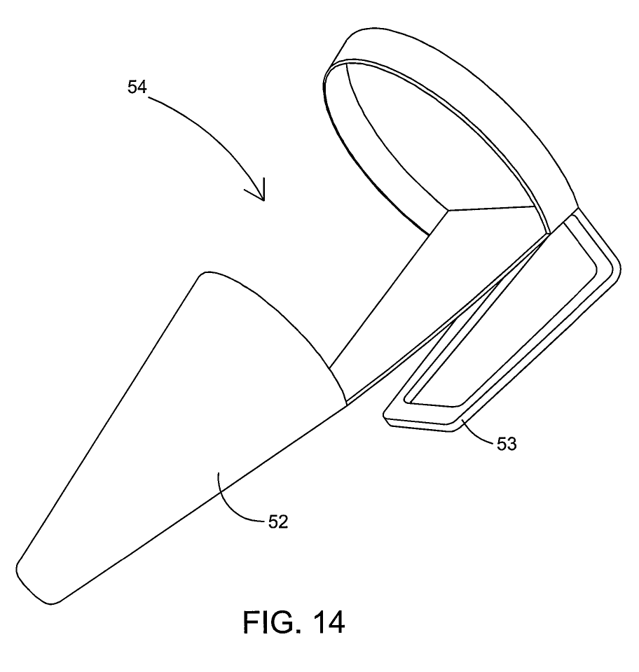

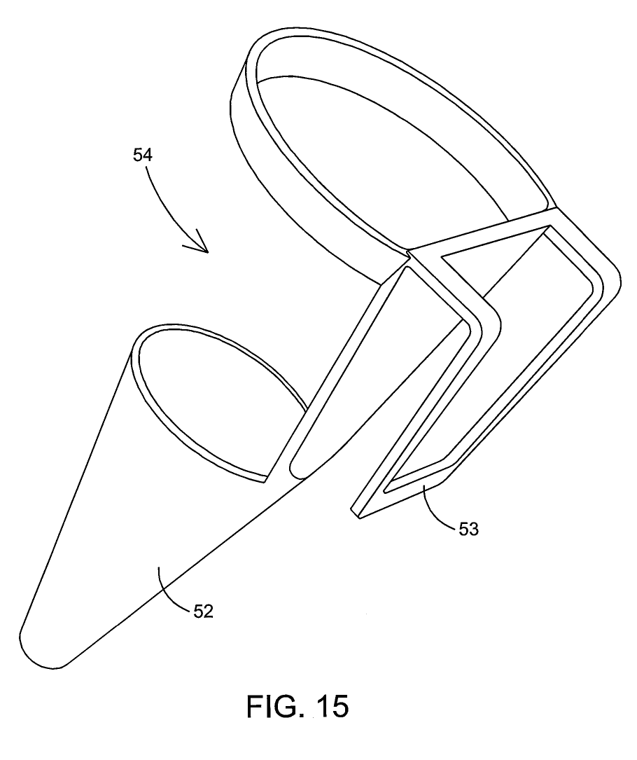

Referring now to FIGS. 14 and 15, another embodiment of the present invention is shown as holder 52. Holder 52 has a bracket 53 that is formed as a single strip of material to permit the bracket to be constructed with less material than would otherwise be needed as with other embodiments of the present invention. In addition, a cutaway section of holder 52 defines an opening 54 that permits holder 52 to function in the same way for holding flowers, while requiring less material.

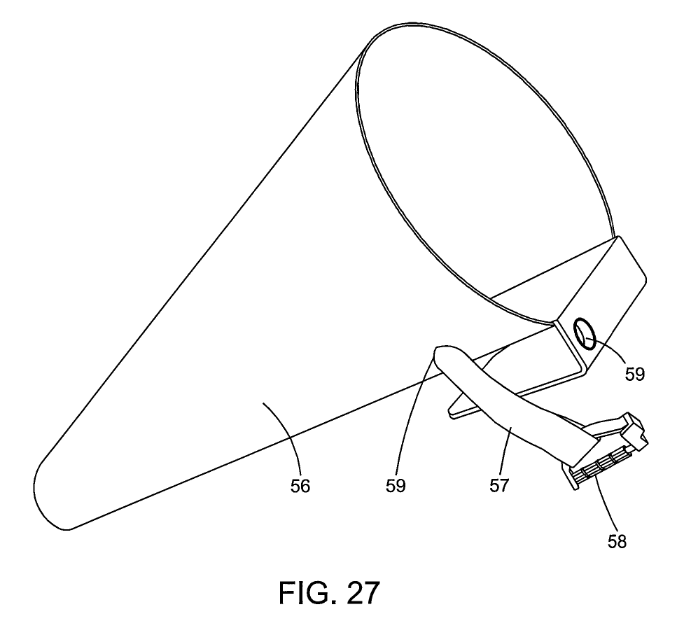

Referring now to FIG. 27, another embodiment of the present invention is shown as holder 56. Holder 56 can have one or more openings 59, illustrated as being in a sidewall and/or in a support device, to permit attachment of a strap 57. Strap 57 is shown anchored on an internal side of holder 56 through opening 59. Strap 57 is attached to a clasp 58 with a sewn loop. It should be apparent that strap 57 need not literally be a strap, but can also be provided in the form of a rope, cable, permanent tether, and so forth. Clasp 58 is constructed to be easily attached to a wall portion of cart 37. Clasp 58 can be permanently attached to cart 37 without the use of tools. Clasp 58 in an open state is placed around a structural member of a wall of cart 37 and secured in a closed position to thereby attach holder 56 to cart 37 through strap 57. The length of strap 57 is selected to permit holder 56 to be placed on an inside or an outside surface of cart 37, or to permit water held in holder 56 to be easily removed by inverting holder 56.

In each of the embodiments described in FIGS. 3-15 and 27, the respective holders have a closed bottom end. Accordingly, the holders are suitable for holding fluid such as water, which permits the supported flowers to be kept fresh. All the holders are also constructed to be resistant to outdoor elements, such as heat, humidity, freezing temperatures, snow, ice, direct sun and rain. If a holder is subjected to precipitation while residing outside of a shopping establishment, the precipitation can easily be removed by emptying the holder outside the shopping establishment prior to use of the cart within the shopping establishment.

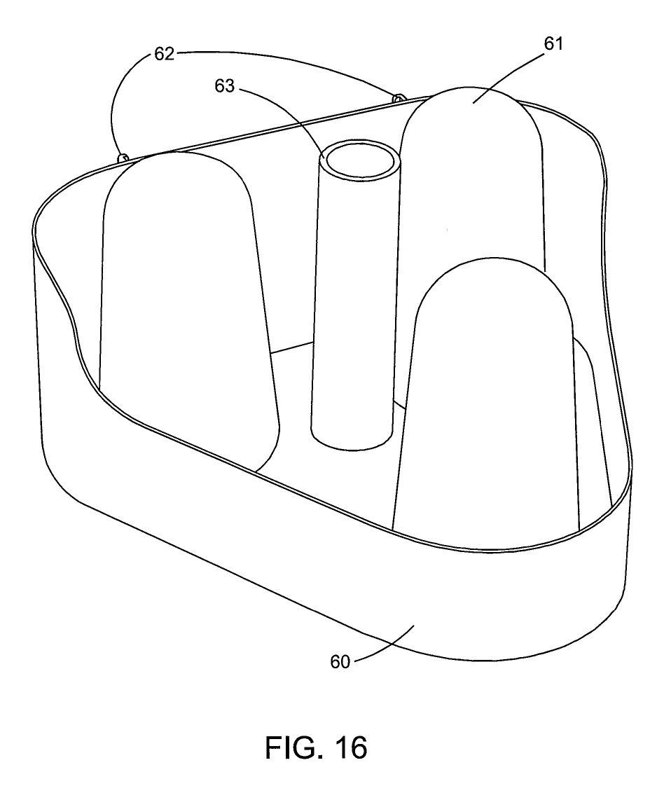

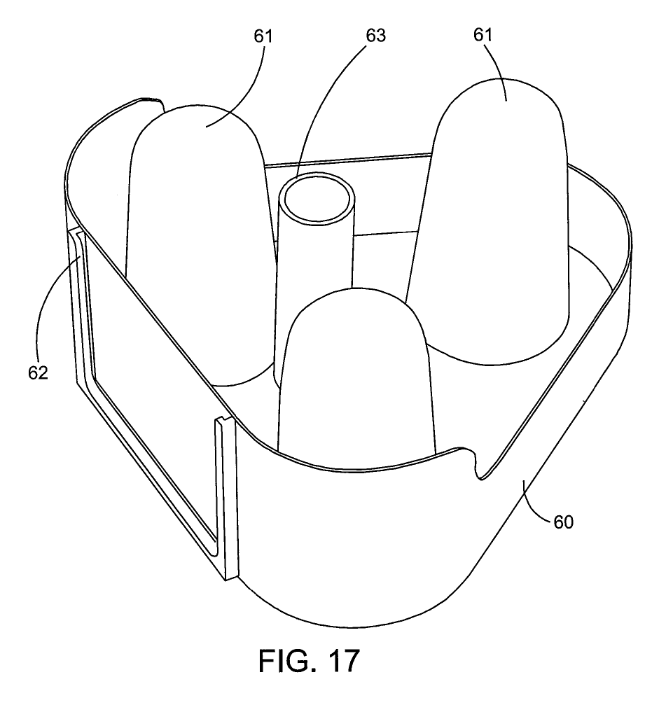

Referring now to FIG. 16, holder storage and display device 60 is shown. Display device 60 acts as a base for supporting and installing holders, while also supporting display items, such as signs, instructions, or coupons. Display device 60 has protrusions 61 for receiving any of the above described flower holders. The flower holders are placed on protrusions 61 upside down, and the holders can be stacked on top of each other with support from protrusions 61.

Display device 60 also includes a support 63 in the shape of a cylinder, into which can be placed a rod that can support a display such as a sign. In addition, display device 60 includes spaced brackets 62 that can receive a display sign directly, as seen more clearly in FIG. 17. Display device 60 can be used to transport and store flower holders simply and easily in a stable manner.

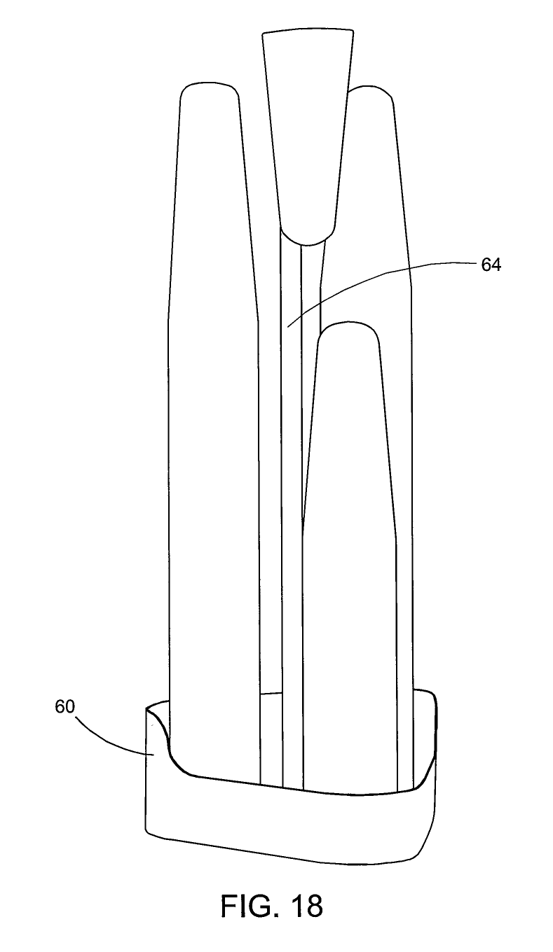

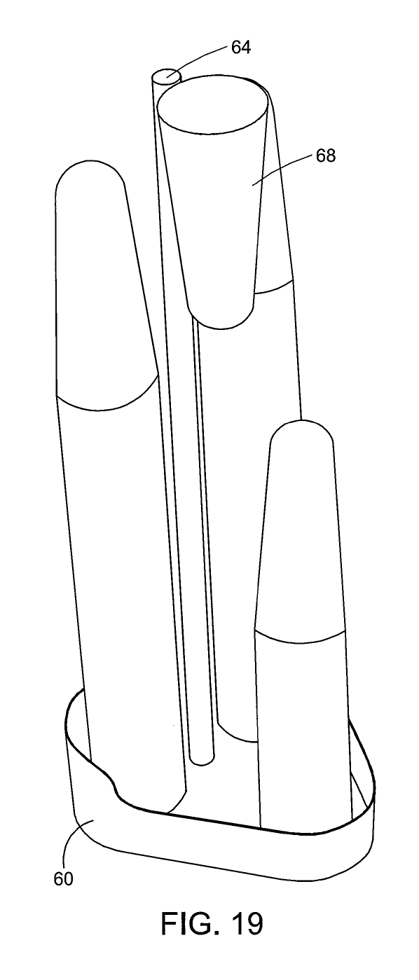

Referring now to FIG. 18, display device 60 is shown with stacks of flower holders and a rod 64 supporting another flower holder used for display purposes. The flower holder stacked in display device 60 can easily be removed by employees of the shopping establishment for installation on shopping carts, or can be selected by shoppers for use with individual carts. FIG. 19 shows another perspective view of the embodiment of FIG. 18, in which the relationship of rod 64 to display holder 68 is shown.

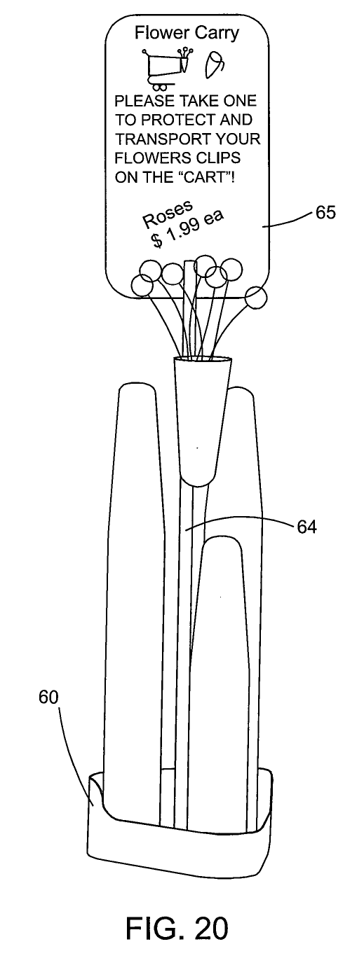

Referring now to FIG. 20, display device 60 is shown with a display item 65 attached to rod 64. Display item 65 can be a sign or other informative material, such as a pamphlet or brochure holder, sign, instructions or advertisements. Display item 65 can provide shoppers with information about selection of flower holders for use with transporting and purchasing flowers from the shopping establishment. In addition, display item 65 can inform shoppers about special items such as flower sales or specialty plants and flowers.

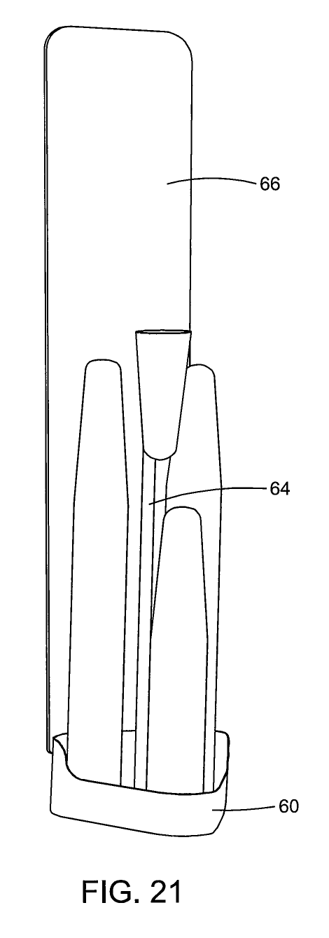

Referring now to FIG. 21, an upright display 66 is shown in a slot defined by brackets 62. Display 66 can provide some of the same functions as display item 65 shown in FIG. 20 by informing shoppers about flower sales or specials, while encouraging shoppers to use a flower holder for their flower purchases. It should be apparent that display 66 can be used in conjunction with rod 64 and display item 65 at the same time, or to provide for permanent and temporary display information, for example.

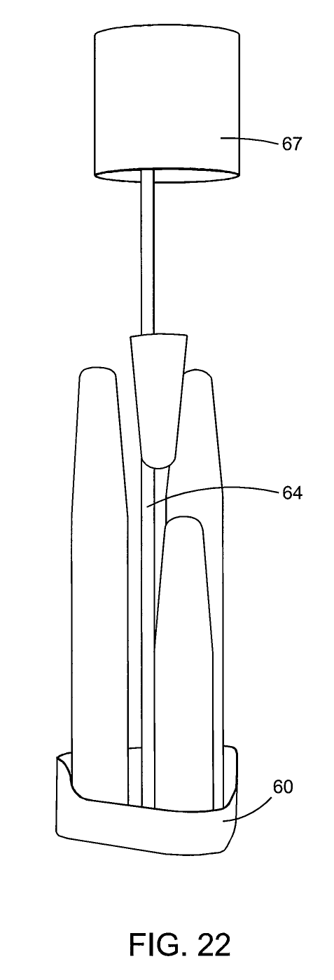

Referring now to FIG. 22, display device 60 is shown with a cylindrical display member 67 attached to rod 64. The cylindrical shape of display member 67 permits information on display member 67 to be viewed by shoppers in a variety of directions. Again, the features of display device 60 permit upright display 66 shown in FIG. 21 to be used in conjunction with display member 67.

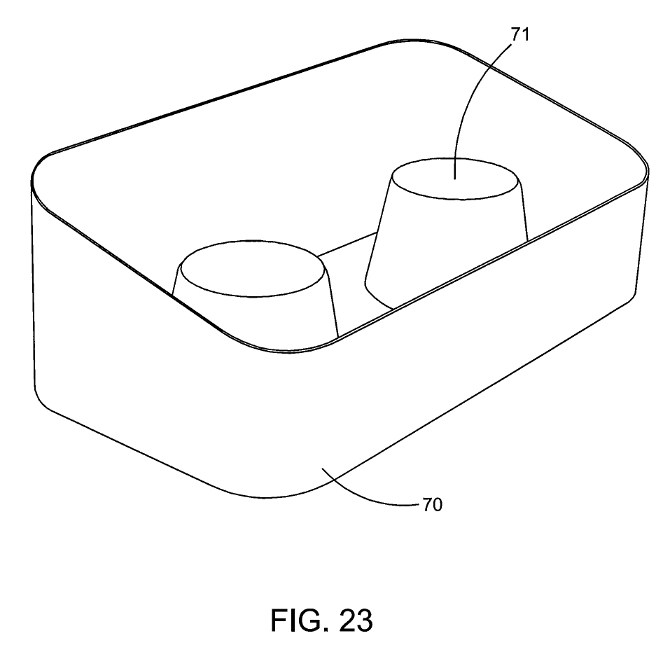

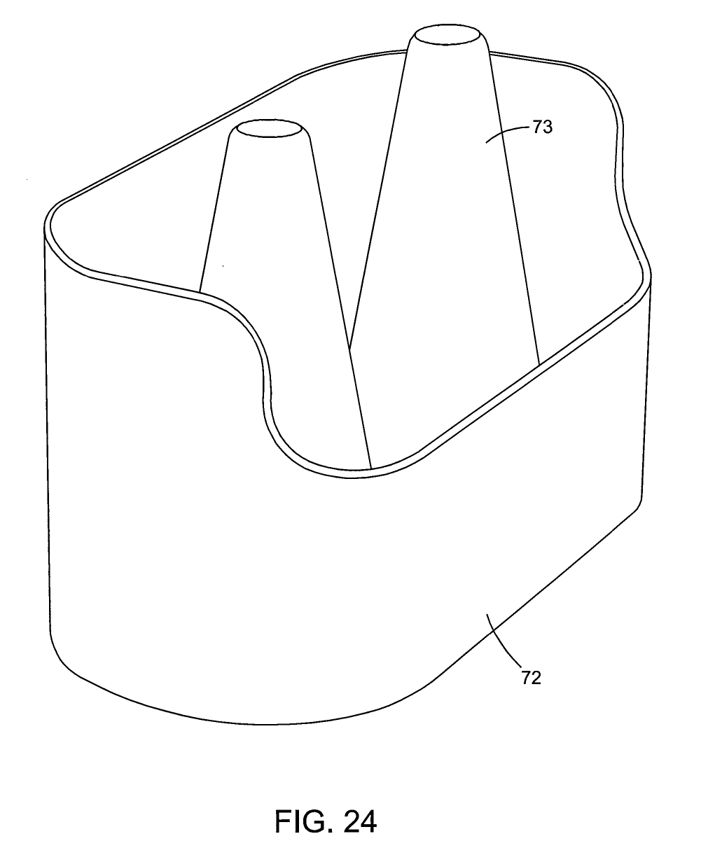

Referring now to FIG. 23, another embodiment of a flower holder display stand is shown as display stand 70. Display stand 70 has protrusions 71 in the shape of cylinders with sloped sides. Protrusions 71 permit the cone shaped flower holders to be placed upside down on protrusion 71 and stacked for display, transportation or storage. Display stand 70 has only two protrusions 71, thereby requiring less material than display device 60. In addition, since protrusions 71 are formed in the shape of a cutoff cone section, less material is required to form protrusion 71, while still incorporating the same functionality as, for example, protrusion 61.

Referring now to FIG. 24, another embodiment of a flower holder stand is shown as display stand 72. Display stand 72 has higher walls to provide extra stability for stacked flower holders on protrusions 73. In addition, protrusions 73 are formed in the shape of cone shaped flower holders to permit such holders to be stacked securely. Accordingly, display stand 72 can support stacks of flower holders more securely, and in greater numbers than can display stand 70 shown in FIG. 23.

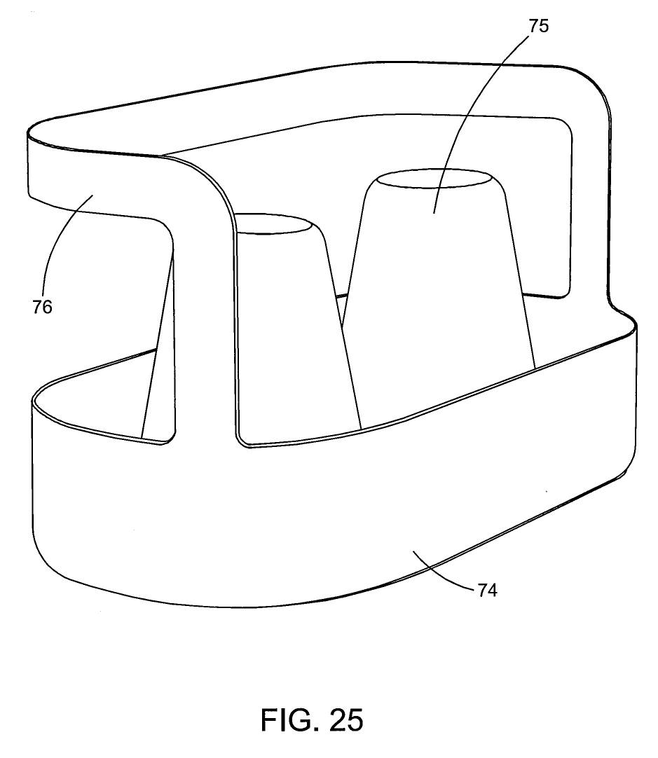

Referring now to FIG. 25, a further embodiment of a flower holder display device according to the present invention is shown as display stand 74. Display stand 74 has protrusions 75 for receiving flower holders placed upside down on protrusion 75. Display stand 74 is also provided with a handle 76 that can be used to support and transport display stand 74, even when loaded with flower holders supported by protrusions 75. Handle 76 can also be used as a support for securing a sign or other informative displays to display stand 74.

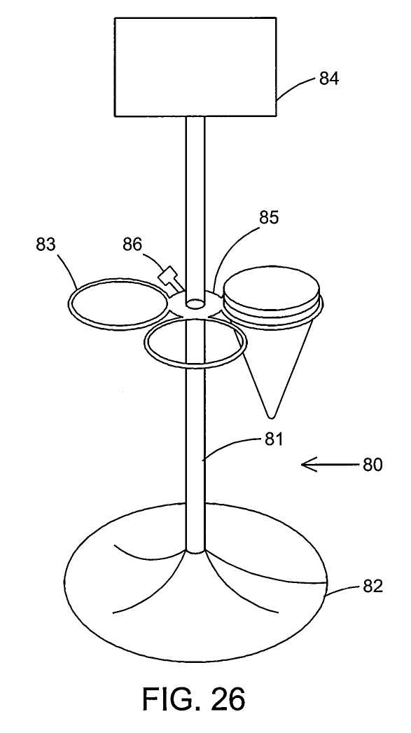

It should be apparent that the above described display devices and display stands shown in FIGS. 16-25, and the display stand shown in FIG. 26, discussed in more detail below, can have a closed bottom end that is watertight. For example, if a flower holder is placed upside down on protrusion 61 of display device 60, any water in the flower holder is likely to descend down protrusion 61 and remain in a bottom portion of display device 60. By having the bottom portion of display device 60 be watertight, the water collected as described above can be prevented from leaking out of display device 60 and prevent potentially hazardous conditions such as a slippery floor in the area of display device. In addition, flower holders placed on protrusions 61, for example, may contain leftover water from a previous use, or collected as a result of precipitation when the holders have been located outside of the shopping establishment. By arranging protrusion 61 to receive flower holders that are inverted, a shopper selecting a flower holder from display device 60 can obtain a flower holder that is emptied of water or precipitation. By having display device 60, for example, be watertight, any excess water or precipitation removed from the inverted flower holders held by protrusions 61 can remain within display device 60. It should be noted, however, that display device 60, for example, need not be watertight but rather can serve as a simple structure for supporting flower holders for display.

Referring now to FIG. 26, another embodiment of a display stand according to the present invention is shown as display stand 80. Display stand 80 has a rod 81 supported by a base 82. Rod 81 has various rings 83 attached, which serve as flower holder support and display devices. Rings 83 are attached to inner ring 85, which is sized to accommodate rod 81. A set screw 86 tightly contacts rod 81 to prevent inner ring 85 and rings 83 from vertical movement. Set screw 86 can be released from contacting rod 81 to permit rings 83 and inner ring 85 to be placed at various positions along rod 81, whereupon set screw 86 can be retightened to secure rings 83 and inner ring 85 to rod 81.

Flower holders can be stacked in the rings 83 for simple storage and retrieval by shoppers. In addition, a height of rings 83 above support stand 82 can be adjusted to permit rings 83 to support varying numbers of flower holders. Rings 83 are sized to support flower holders formed in the shape of a cone, so that a cone shaped flower holder placed in a ring 83 can be stabily supported at a distance from the opening of the flower holder. That is, rings 83 are slightly smaller in diameter than the opening of a flower holder, so that the flower holder is securely supported when placed in ring 83. With this arrangement, a number of flower holders can be stacked on top of each other, with the bottom flower holder being supported by ring 83. This arrangement provides a stabile stacking configuration to permit flower holders to be stacked in large numbers.

Display stand 80 can also include an information display 84 that can be in the form of an advertisement, instructions, brochures, coupons, signs or other information during the selection of flowers or the use of flower holders. Display 84 can be provided as any number of display types, as described previously.

In addition, it should be apparent that display stand base 82 can be formed in a shape to catch and retain excess fluids that can potentially flow off of flower holders stacked in rings 83. Rings 83 need not be closed circles as is illustrated in FIG. 26, but rather can be any type of support mechanism that contacts and supports the sides of the supported flower holders.

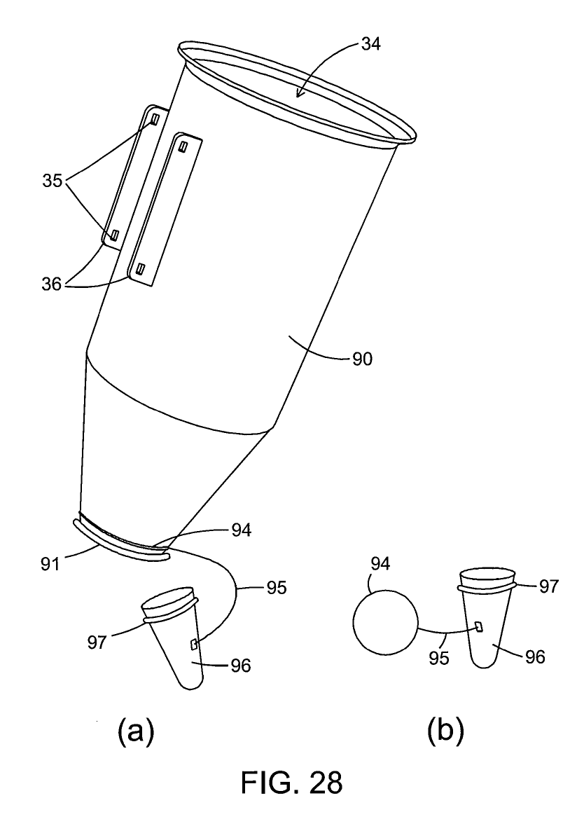

Referring now to FIG. 28, a flower holder 90, similar in design to that shown in FIG. 1 is illustrated. In addition to having the features described for the holder illustrated in FIG. 1, for which a description is not repeated here, holder 90 has a lip 91 on a bottom portion. Lip 91 forms part of a pressure fit coupling for use with attaching a detachable cup 96. Detachable cup 96 has a cooperating lip 97 that provides a water-tight seal with lip 91 when cup 96 is attached over lip 91 on holder 90. Cup 96 has a sealing ring (not shown) on an interior of cup 96 that provides further sealing action. A tether 95 couples cup 96 to holder 90, through a ring 94. Ring 94 fits over lip 91 on holder 90, and resists being withdrawn from holder 90 by having a slightly smaller circumference than lip 91. Accordingly, ring 94 can be assembled easily over lip 91 to provide a complete flower holder assembly.

Cup 96 can be easily and securely attached and detached to and from holder 90, respectively. Because cup 96 forms a water-tight seal with holder 90, cup 96 and holder 90 can both carry water sufficient to maintain freshness for flowers transported in holder 90. In addition, the water-tight seal prevents liquid from spilling on a floor of a shop from holder 90, thus avoiding potentially hazardous situations in which personal injury may occur through slips and falls. If holder 90 is to be emptied of water, for example after collecting precipitation while outdoors, the water can be quickly and easily emptied by detaching cup 96 and permitting the water to be evacuated from holder 90 through the lower opening. Tether 95 prevents cup 96 from being misplaced or separated from holder 90, so that holder 90 can readily be made water-tight by attaching cup 96.

Ring 94 fits loosely around the lower portion of holder 90 once installed over lip 91. When cup 96 is attached, ring 94 slides slightly upward and away from cup 96 and provides enough clearance for lips 91 and 97 to engage in a water-tight seal.

It should be apparent that cup 96 can be tethered to holder 90 with any convenient configuration. Such configurations can include a tether permanently attached to holder 90, such as molded tether, a strap secured through an opening in holder 90, or a tether through an opening 35, for example. Alternatively, cup 96 can be tethered to a shopping cart in a region sufficiently close to holder 90 to permit cup 96 to be attached or detached easily to permit water held in holder 90 and cup 96 to be easily discharged.

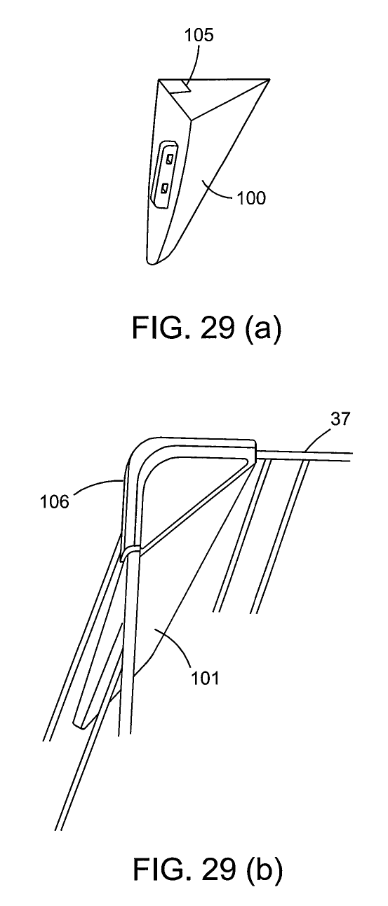

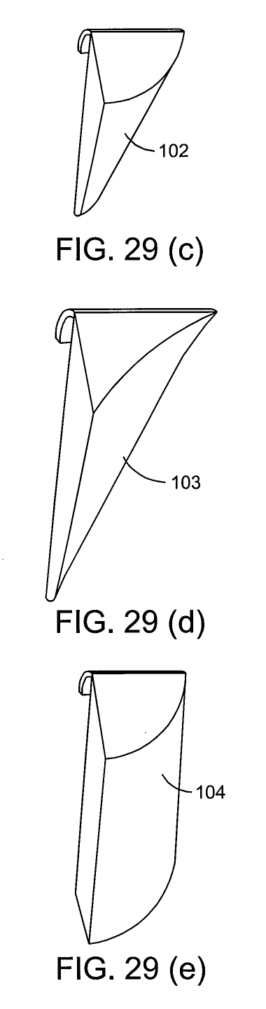

Referring now to FIG. 29, various embodiments of flower holders are shown, each representing sleight variations in form and usage. In FIG. 29(a), a holder 100 shaped as a tetrahedron is shown. A corner of holder 100 is substantially a right angle, as indicated by right angle symbol 105. The right angle corner of FIG. 29(a) fits into a corner of a shopping cart to permit greater space availability in the cart. FIG. 29(b) shows a tetrahedral shaped holder 101 with a corner bracket 106 supporting holder 101 on cart 37. FIG. 29(c) shows a corner oriented holder 102 that has a convexly arcuate surface that faces an interior of a shopping cart. FIG. 29(d) shows a similar holder 103 with a concavely arcuate surface facing an interior of a shopping cart. FIG. 29(e) shows a columnar holder 104 that is shaped as a portion of a cylinder, with a cross section that is a quarter circle. It should be apparent that each of these flower holders are adaptable to be mounted either on an inner or on an outer side of a shopping cart.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A flower holder for use with a shopping cart for holding flowers, comprising:
a chamber in the holder, the chamber having a longitudinal axis;
a first opening in the holder communicating with the chamber for receiving flowers into the chamber;
a cross-sectional portion of the chamber taken transverse to the axis and spaced from the first opening along the axis, a region of the cross-sectional portion capable of contributing lateral support to flowers received into the chamber; and
a support member on the holder for supporting the holder on the shopping cart,
further comprising an attaching device cooperating with the support member to secure the holder to the shopping cart; and
further comprising:
an attachment opening in the support member for attaching the attaching device; and
the attaching device comprises a member extending through the attachment opening for fixing the flower holder to the shopping cart.

2. A flower holder according to claim 1, further comprising a removable container in the chamber, the container having a container opening communicating with the container and the first opening in the chamber for receiving flowers inserted through the first opening into the container.

3. A flower holder according to claim 1, further comprising:
a second opening communicating with the chamber and opposite the first opening;
the second opening being below the first opening when the holder is supported on the shopping cart.

4. A flower holder according to claim 3, wherein the second opening is arranged to prevent or permit passage of portions of the flowers received into the first opening.

5. A flower holder according to claim 3, further comprising a removable container in the chamber, the container having a container opening communicating with the container and the first opening in the chamber for receiving flowers inserted through the first opening into the container.

6. A flower holder according to claim 5, wherein a portion of the container extends through the second opening in the chamber, such that an edge of the opening contacts the container and thereby contributes to supporting the container in the chamber.

7. A flower holder according to claim 1, wherein the attaching device is a cable tie.

8. A flower holder for use with a shopping cart for holding flowers, comprising:
a chamber in the holder, the chamber having a longitudinal axis;
a first opening in the holder communicating with the chamber for receiving flowers into the chamber;
a cross-sectional portion of the chamber taken transverse to the axis and spaced from the first opening along the axis, a region of the cross-sectional portion capable of contributing lateral support to flowers received into the chamber; and
a support member on the holder for supporting the holder on the shopping cart,
further comprising an attaching device cooperating with the support member to secure the holder to the shopping cart;
further comprising:
a second opening communicating with the chamber and opposite the first opening;
the second opening being below the first opening when the holder is supported on the shopping cart, and
further comprising a detachable container attachable to the holder over the second opening, the container forming a water-tight seal when attached to the holder.

9. A flower holder according to claim 8, further comprising a tether coupled to the holder and the container, whereby the container is retained with the holder when detached.

10. A flower holder according to claim 8, further comprising a tether coupled to the cart and the container, whereby the container is retained near the holder when detached.

11. A flower holder according to claim 8, further comprising cooperating lips on the holder and the container, the lips capable of forming the water-tight seal when the container is attached to the holder.

12. A flower holder for use with a shopping cart for holding flowers, comprising:
a chamber in the flower holder for receiving flower portions;
a first opening in the holder communicating with the chamber for insertion of the flower portions;
a tether coupled to the holder for tethering the holder to the shopping cart;
a coupling device on the tether and attachable to the shopping cart to thereby retain the holder on the shopping cart through the tether.

13. A flower holder according to claim 12, wherein the tether is a strap further comprising a sewn loop in the strap, the sewn loop retaining the coupling device.

14. A flower holder according to claim 12, wherein the coupling device is a clip attachable to the shopping cart without the use of tools.

15. A flower holder according to claim 12, further comprising:
a second opening in the holder communicating with the chamber and having an interior side and a dimensional size; and
an enlarged section of the strap on the interior side of the second opening, the enlarged section having a size greater than the dimensional size of the second opening, whereby the strap is prevented from exterior removal.
